(19) United States
(12) Patent Application Publication
(10) Pub. No.: US 2019/0098636 A1
(43) Pub. Date: Mar. 28, 2019

(54) INTERFERENCE BASED RESOURCE ALLOCATION

(71) Applicant: TELEFONAKTIEBOLAGET LM ERICSSON (PUBL), Stockholm (SE)

(72) Inventors: Yufeng ZHAO, Upplands Väsby (SE); Anders WEDIN, UPPSALA (SE)

(21) Appl. No.: 15/740,691

(22) PCT Filed: Jun. 29, 2015
(86) PCT No.: PCT/EP2015/064743

§ 371 Date: Dec. 28, 2017

(51) Int. Cl. H04W 72/08; H04J 11/00; H04W 72/04

(52) U.S. Cl. CPC H04W 72/082; H04W 72/0453; H04W 72/0413; H04J 11/003

(57) ABSTRACT

It is presented a method for determining a position of a wireless device, the method being performed in a network node connected to a plurality of remote radio heads via a combiner. The method comprises the steps of: adjusting a weighting of an uplink signal for at least one of the remote radio heads; measuring a signal quality of a combined uplink signal received via the combiner; repeating the steps of adjusting and measuring until an exit condition is true; and determining a position of the wireless device based on how the measured signal quality differs for adjustments of weighting of the uplink signal for different remote radio heads.

### TECHNICAL FIELD

The invention relates to uplink interference in wireless communication networks, and in particular to utilizing knowledge about interference for making decisions related to allocation of resources.

### BACKGROUND

Interference is a source of problems in wireless communication. There are many types of interference in a wireless communication system, such as e.g. inter-cell interference and intra-cell interference.

Significant interference may be caused due to the so-called “near far problem”, which is illustrated in FIG. 1. The “near far” implies that an interfering transmitter 101, which is near (i.e. is close to or has a low pathloss to the transmitter for other reasons) a first receiver 102, transmits signals to a second receiver 103 which is far away (or has a high pathloss in relation to the transmitter for other reasons) and therefore uses a high transmit power and therefore causes interference to the first receiver 102. The first receiver 102 may in such a case be denoted a “victim” receiver, implying that it “suffers” from interference caused by the interfering transmitter. The higher output power the interfering transmitter uses, and the closer the interfering transmitter is to the victim receiver, the more interference is caused to and received by the victim receiver.

One specific type of interference is so-called Adjacent Channel Interference, ACI, which will be used as an illustrative example herein. ACI is interference which is caused by extraneous power from a signal in an adjacent channel, where “adjacent” is in terms of frequency. ACI occurs because the spectrum mask of the interfering transmitter is not ideal, due to that radio frequency, RF, filters require a “roll-off” 201, which is also illustrated in FIG. 2. Due to the roll-off 201, the RF filter does not eliminate the interference to adjacent channels completely. Therefore, the interfering transmitter emits some power also in the adjacent channel, which is received e.g. by a base station receiving signals from a wireless device in the channel subjected to the interference.

In traditional outdoor systems, with base station antennas placed e.g. on roof tops and in antenna towers, interfering transmitters, such as wireless devices, typically never come closer to the base station antennas than a defined minimum distance. Therefore, the UL ACI for the outdoor scenario is often not that severe.

However, in an indoor system, as the one illustrated in FIG. 3, interfering transmitters, e.g. in form of UEs 302, may be connected to an outdoor base station 303. The indoor radio conditions for outdoor base stations are often bad, e.g. due to the outer wall loss. Therefore, a UE 302 being located indoors but being connected to an outdoor base station 303 need to use a highest transmit power when communicating with the outdoor base station 303. At the same time, the UE 302 may come very close to the indoor antenna 304. In cases when the interfering UE 302 (connected to the outdoor base station 303) cannot be handed over, i.e. connect, to the indoor system 304, it may generate severe interference to the indoor system 304. In case the outdoor base station 303 and the indoor system 304 operate in adjacent frequency bands, the interfering UE 302 will cause uplink ACI to the indoor system 304. In an indoor UL ACI scenario, all indoor UEs 305 that are connected to a cell represented by the interfered indoor antenna 304 will be affected.

Indoor systems which do not support multi-operator or multi-band operation have a higher relative risk (than indoor systems supporting multi-operator or multi-band operation) of being impacted by interference caused by wireless devices remaining connected to an outdoor macro base station also when located indoors. Therefore, it is particularly important to develop strategies for mitigating interference for such systems. In other words, such systems may benefit to an extra high extent from strategies for mitigating interference between channels, cells and systems.

There are already many features developed to reduce interference. However, when indoor and outdoor systems have different Radio Access Network, RAN, vendors, the developed Coordination and/or Cancellation features often cannot be applied due to limited cooperation between the systems.

Some examples of state of the art strategies for reducing interference in OFDM based LTE systems will be given below:

UL FSS: In UL Frequency Selective Scheduling, UE and Resource Block, RB, allocation for PUSCH transmissions will be performed based on per-UE frequency-dependent channel knowledge. However, the channel differences measured by sounding signals in indoor environments can be limited due e.g. to use of distributed antennas in indoor system. UL FSS requires a proportion fair scheduler and is typically not recommended for indoor systems. Results from field trials show that UL FSS and Proportional Fair Scheduling, PFS, are beneficial in lower load situations, but that Round Robin has better performance in high load situations. Further, Sounding Reference Signals, SRS, will take resources from PUSCH, leading to lower spectrum efficiency.

ICIC-Autonomous Resource allocation: This feature selects randomly where in the spectrum band the resource allocation starts. It can also be configured to use only a part of the spectrum. The feature aims to reduce the co-channel interference caused by neighbor cells that use the “same” RBs simultaneously.

### SUMMARY

It is desirable to mitigate the impact of uplink interference, particularly in indoor systems. As realized by the inventors, certain types of uplink interference have long term statistic patterns that can be utilized for analyzing and mitigating the impact of this interference. For example, knowledge of the long term statistic pattern of the uplink interference in an indoor system may be used e.g. for reducing the impact of ACI caused e.g. by devices communicating with outdoor systems.

According to a first aspect, a method is provided, which is to be performed in a wireless communication network. The method comprises obtaining an accumulated uplink interference for a time period, Ti, over a frequency spectrum associated with an uplink communication channel of the wireless communication network. The method further comprises dividing the frequency spectrum into at least a first and a second range based on characteristics of the obtained accumulated interference. The method further comprises applying different rules for allocation of resources to wireless devices for uplink communication in the channel in the first and second range.

According to a second aspect, a network node is provided, which is operable in a wireless communication network. The network node is configured to obtain an accumulated uplink interference for a time period, Ti, over a frequency spectrum associated with an uplink communication channel of the wireless communication network; and to divide the frequency spectrum into at least a first and a second range based on characteristics of the obtained accumulated interference. The network node is further configured to apply different rules for allocation of resources to wireless devices for uplink communication in the channel in the first and second range.

According to a third aspect, an arrangement operable in a wireless communication network is provided. The arrangement is configured to obtain an accumulated uplink interference for a time period, Ti, over a frequency spectrum associated with an uplink communication channel of the wireless communication network. The arrangement is further configured to divide the frequency spectrum into at least a first and a second range based on characteristics of the obtained accumulated interference. The arrangement is further configured to apply different rules for allocation of resources to wireless devices for uplink communication in the channel in the first and second range.

According to a fourth aspect, a computer program is provided, which comprises instructions which, when executed on at least one processor, cause the at least one processor to carry out the method according to the first aspect.

According to a fifth aspect, a carrier is provided, which contains a computer program according to the fourth aspect, wherein the carrier is one of an electronic signal, optical signal, radio signal, or computer readable storage medium

### BRIEF DESCRIPTION OF THE DRAWINGS

The foregoing and other objects, features, and advantages of the technology disclosed herein will be apparent from the following more particular description of embodiments as illustrated in the accompanying drawings. The drawings are not necessarily to scale, emphasis instead being placed upon illustrating the principles of the technology disclosed herein.

FIG. 1 is a schematic view showing an exemplifying scenario where interference may be caused due to the so-called near-far problem.

FIG. 2 is a schematic diagram illustrating adjacent channel interference.

FIG. 3 is a schematic view showing an exemplifying scenario where interference may be caused to an indoor system.

FIGS. 4-6 are flowcharts illustrating exemplifying methods performed in a wireless communication network by a network node or an arrangement according to different embodiments.

FIG. 7 is a diagram illustrating an accumulated uplink interference over a frequency spectrum associated with an uplink communication channel for three cells.

FIG. 8 is a diagram illustrating division into regions of a frequency spectrum associated with an uplink communication channel according to an exemplifying embodiment.

FIGS. 9a-9c are schematic block diagrams illustrating different implementations of a network node, an arrangement or a network, according to exemplifying embodiments.

FIGS. 10-11 are schematic block diagrams illustrating different implementations of a wireless communication network, in which embodiments may be applied in a distributed or non-distributed manner.

### DETAILED DESCRIPTION

The solution described herein relates to utilizing patterns in an accumulated interference when allocating resources to wireless devices for uplink communication.

By analyzing the accumulated interference over frequency, e.g. per RB in an LTE-type system, a pattern of the interference within the spectrum can be identified. For ACI, for example, the accumulated interference has the pattern that the highest interference appears at spectrum edge, and gradually decreases to an average level at the center of the spectrum. However, in various situations there may also be other types of interference that contributes to the long term pattern of accumulated uplink interference, which may have a similar or other distribution. The solution described herein is mainly intended for systems applying OFDM for communication, and is applicable both for Time Division Duplexing, TDD, and Frequency Division Duplexing, FDD.

According to an exemplifying embodiment of the proposed solution, a spectrum associated with an uplink channel of a cell is divided into 2 ranges or parts based on the characteristics of the accumulated interference, when ACI is identified. One range being associated with low ACI; and one range being associated with high ACI. Parameters like UE pathloss, which data to send, and the load of the cell may be used as base for decisions of from which range resources should be allocated for an uplink communication. For example, when the cell load is low, all UEs may be scheduled in the low ACI range. On the other hand, when the cell load is high, at least the UEs with high pathloss (e.g. cell edge UEs) may be scheduled in the low ACI area; while UEs with low pathloss can be scheduled in the high ACI range. Other parameters, such as the size of the amount of data to transmitted (small amounts can be transmitted using fewer RBs), and/or traffic data type, such as guaranteed bitrate data or not, may be considered for deciding where to allocate resources for a wireless device.

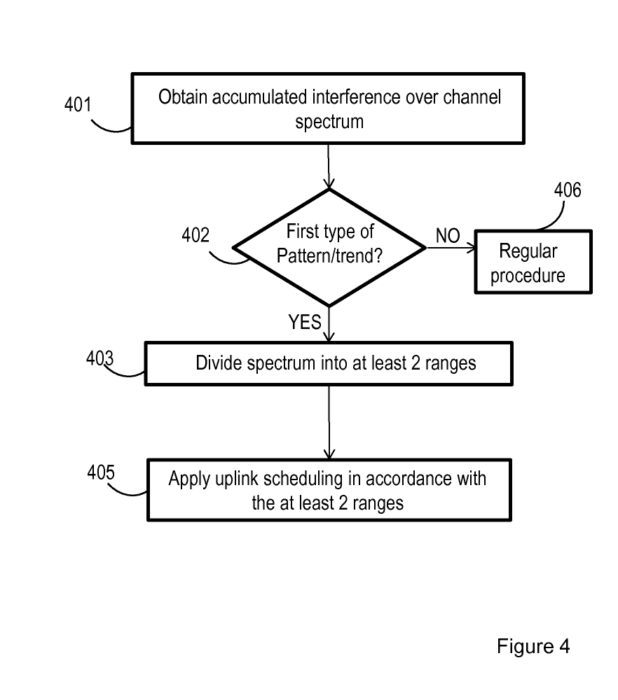

A generic embodiment of a method according to the solution presented herein is illustrated in FIG. 4. The method is to be performed in a wireless communication network, e.g. by a network node or an arrangement operable in the wireless communication network. For example, the method could be performed by a radio access node, such as an eNB or an indoor node. The method could be performed in a distributed manner, i.e. different actions could be performed in different locations in the network, e.g. in a so-called cloud solution, or a “Centralized RAN” or “Split Architecture”, where e.g. an eNodeB is divided into 2 or more separate nodes. Correspondingly, the method could be performed e.g. partly in a radio access node and partly in a core network node. The distributed case could be described as that the method is performed by an arrangement or by a network node, where the arrangement or the network node could be distributed in the network, and not necessarily be comprised in a physical unit e.g. close to an antenna.

The method comprises obtaining 401 an accumulated uplink interference over a frequency spectrum associated with an uplink communication channel in the wireless communication network, e.g. of a cell or node. The frequency spectrum may be associated with an uplink communication channel, such as the Physical Uplink Shared Channel in LTE, or alternatively a differently denoted channel, which is used for uplink transmission of payload. The accumulated uplink interference is related to, i.e. collected during, a time period T, which is significantly longer than a subframe or TTI. The time period Ti may have a duration e.g. of minutes or hours, which will be further discussed below. The method further comprises dividing 403 the frequency spectrum into at least a first and a second range based on characteristics of the obtained accumulated interference. The method further comprises applying different rules for allocation of resources to wireless devices for uplink communication in the first and second range.

The accumulated uplink interference may be obtained e.g. by the measured Noise and Interference Power on PUSCH, according to 3GPP TS 36.214. For example, the accumulated interference power for each resource block can be obtained by samples summed over the measurement period. One sample can be in the range of per 10-100 ms. Measurements may be averaged over receive antennas. An average per frequency, or per resource block, over the time period T could also be used as representing the accumulated interference.

The dividing of the spectrum into at least two regions or parts may be restricted to being performed when a certain type of pattern is present in the obtained accumulated interference. Here, the kind of patterns for which it is relevant or beneficial to divide the spectrum will be referred to as a first type pattern. The method e.g. illustrated in FIG. 4 could then comprise detecting 402 a first type of pattern over frequency in the obtained accumulated interference, and dividing the spectrum e.g. only when such a pattern is detected. In other words, the dividing 403 into at least a first and a second range may be performed when a first type of pattern over frequency is detected 402 in the obtained accumulated interference. The first type of pattern may be detected based on analysis of changes in the accumulated interference between spectrum edge and spectrum center. The analysis of such changes may also be referred to e.g. as “trend analysis”.

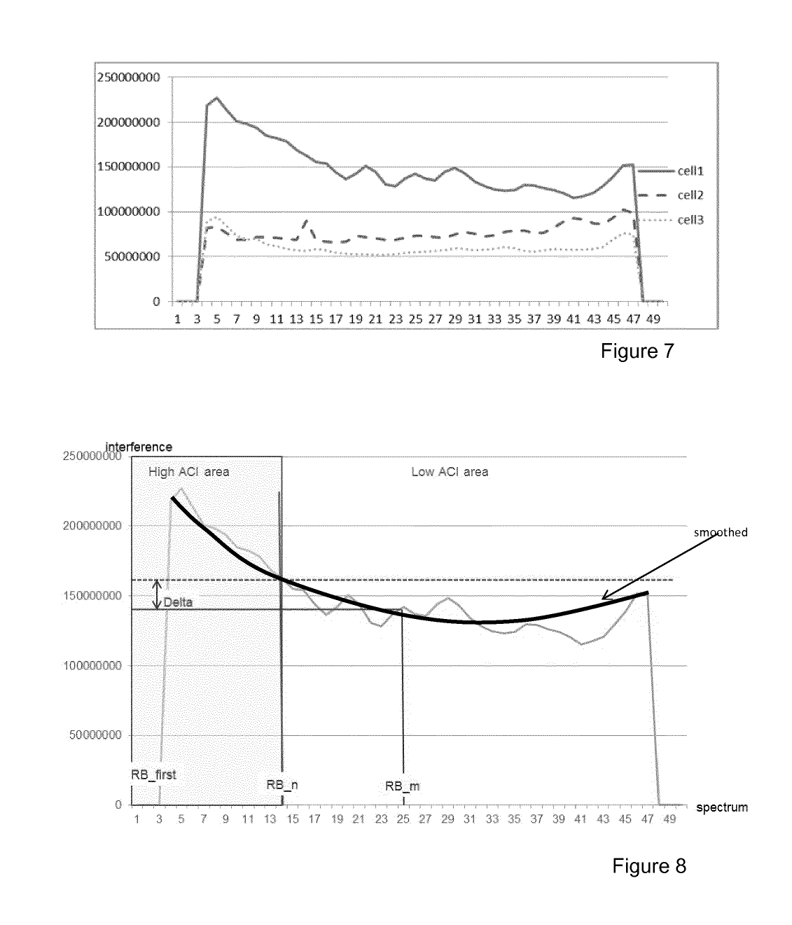

The accumulated interference patterns, i.e. the shape of the accumulated interference curves over frequency, shown in FIGS. 7 and 8 are examples of the first type of pattern. Generally, it could be said that patterns having a relatively continuous slope or trend (increasing or decreasing) between the edge of the frequency spectrum to the center of the frequency spectrum, and where there is a certain absolute or relative difference, e.g. exceeding a threshold, between the accumulated interference at the edge and the center of the spectrum are probably comprised in the first type of patterns. The pattern could have the approximate shape of a concave curve, when observing it in a diagram as the one illustrated in figure X, but could alternatively have a convex shape, and still belong to the first type of patterns. However, when the pattern of the accumulated interference has a “spiky” character over the frequency spectrum it is probably not comprised in the first type of patterns.

The pattern of the obtained accumulated uplink interference could be detected e.g. by a trend analysis between the accumulated interference on spectrum edge and the accumulated interference on the spectrum center. By performing such a trend analysis, it could be detected whether the accumulated interference decreases or increases when moving from the center of the spectrum towards the edge. It may further be detected whether the accumulated interference has a spiky character or not.

The frequency spectrum may be divided into e.g. two or three ranges based on characteristics of the accumulated uplink interference. These ranges may alternatively be referred to e.g. as parts, areas, segments or portions. The division into ranges may be performed e.g. at frequencies or resource blocks where the accumulated interference meets a threshold. This will be further exemplified below, where an algorithm for finding such frequencies will be presented.

Regarding the at least first and second ranges into which the frequency spectrum is divided, the first range may be associated with a lower accumulated interference than the second range. When the frequency spectrum is divided into three ranges, one could be associated with a lower accumulated interference than the others. Another possibility would be that one range is associated with higher accumulated interference than the two other ranges which are associated with lower accumulated interference.

The obtained accumulated uplink interference is collected or measured over a time period, which here will be denoted T. The time period T should have a duration long enough to capture the long term character of the uplink interference, which means that T needs to be substantially longer than the duration of a few Transmission Time Intervals, TTIs (tens of milliseconds). For example, depending on circumstances, the time period T could have a duration of at least e.g. 15 minutes, 1 hour or 5 hours. For example, the uplink interference may be accumulated during the so-called “office hours”. Even though a preferred duration may be at least one hour, shorter durations may be used.

It should be noted that the obtained accumulated UL interference is not obtained per wireless device, as for example in frequency selective scheduling. In other words, the obtained accumulated uplink interference does not reflect the momentary conditions for separate wireless devices.

In order to keep the division into ranges up to date, e.g. in case there are changes in the long term uplink interference, the accumulated uplink interference for another time period T may be obtained, e.g. after the last obtaining of an accumulated uplink interference. Assuming that a previously obtained accumulated uplink interference related to the time period Ti, then an accumulated uplink interference for the time period Ti+x could be obtained, where “i” is an index, and “x” is a number, e.g. 1 added to the index i. Then, e.g. in case the new obtained accumulated uplink interference is determined to be different from the previously obtained accumulated uplink interference in a way that requires an update of the division into ranges, such an update of the division may be performed. That is, an embodiment of the solution described herein may comprise updating of the division of the spectrum into at least a first and a second range based on the characteristics of the accumulated uplink interference for the time period, Ti+x. For example, a new accumulated uplink interference may be obtained at regular intervals, and/or be triggered by an event.

The rules for allocating resources to wireless devices in the at least first and second region may relate to or depend on a pathloss associated with each wireless device and/or a load level of e.g. a cell or network node with which the frequency spectrum is associated. The rules may also relate to or depend on the type of traffic that is to be scheduled for uplink communication in the channel. For example, the rules may relate to that wireless devices are to be scheduled for uplink communication in the first range at a first load level of the cell. The rules for allocating resources to wireless devices for uplink communication may further relate to that wireless devices associated with a pathloss exceeding a threshold are to be scheduled for uplink communication in the first range at a second load level. Correspondingly, the rules may relate to that wireless devices associated with a pathloss below a threshold are to be scheduled for uplink communication in the second range at a second load level. The rules may further relate to that data traffic associated with a guaranteed bitrate, i.e. GBR traffic, is to be scheduled to wireless devices in the first range, e.g. at any load level, and/or that data traffic associated with so-called “best effort” is to be scheduled to wireless devices in the second region, e.g. at any load level. The differentiation of allocation of uplink resources to wireless devices into the at least two ranges may be started e.g. at a certain detected load level. A load level could either be determined as an average over a time period L, or more momentarily. A load level could be detected e.g. based on a buffer fill status and/or based on that there are no more available resources to allocate in one of the regions associated with low accumulated interference.

It should be noted that the rules and decisions concerning which wireless devices that should be allocated resources in which region are not intended to be exercised for each or be related to, e.g. only valid for a, very short term time period, such as per TTI or scheduling period. Instead, the allocation strategy may be changed e.g. when a change of system load is detected, or when a change in the accumulated long term UL interference has been detected, or the like. That is, changes in the allocation strategy are related to parameters, such as load and long term accumulated UL interference, which typically do not change very rapidly For example, a wireless in-door office building communication system load could be high during work hours and low during nights and weekends.

The solution presented herein has been exemplified earlier above, and will be again below, in the context of ACI and indoor systems, since this is an illustrative example. However, the solution is applicable also for other types of systems and interference. In other words, the long term statistic patterns identified and utilized according to the solution described herein do not only apply to ACI and indoor systems, but also to other types of interference and to outdoor systems. The solution described herein is applicable both for TDD and FDD, and is primarily intended for systems applying OFDM for communication, such as e.g. LTE.

Below, it will be exemplified how a certain pattern can be identified, and how the frequency, in form of a RB, where a division into regions is to be performed may be located.

Identifying ACI

In an LTE mobile network, the uplink co-channel interference caused by UEs from neighbor cells is often randomly distributed over the whole spectrum. Over time, the sum of this type of interference on each resource block does not vary too much. So, statistically, all resource blocks suffer from a similar level of the interference.

ACI, however, adds extra interference from the adjacent channel to resource blocks on the edge of the cell spectrum. The sum of all interference on each resource block over time, for ACI, will therefore show a highest value on the spectrum edge resource blocks. FIG. 7 shows the accumulated interference on the Physical Uplink Shared Channel, PUSCH, of three (3) cells from a real network. Resource Blocks, RBs, 1,2,49 and 50 are used for the Physical Uplink Control Channels, PUCCH, and are therefore not included in the figure and not considered for the dividing into ranges. FIG. 8 shows that cell1 (solid line) has ACI also from lower edge of the spectrum.

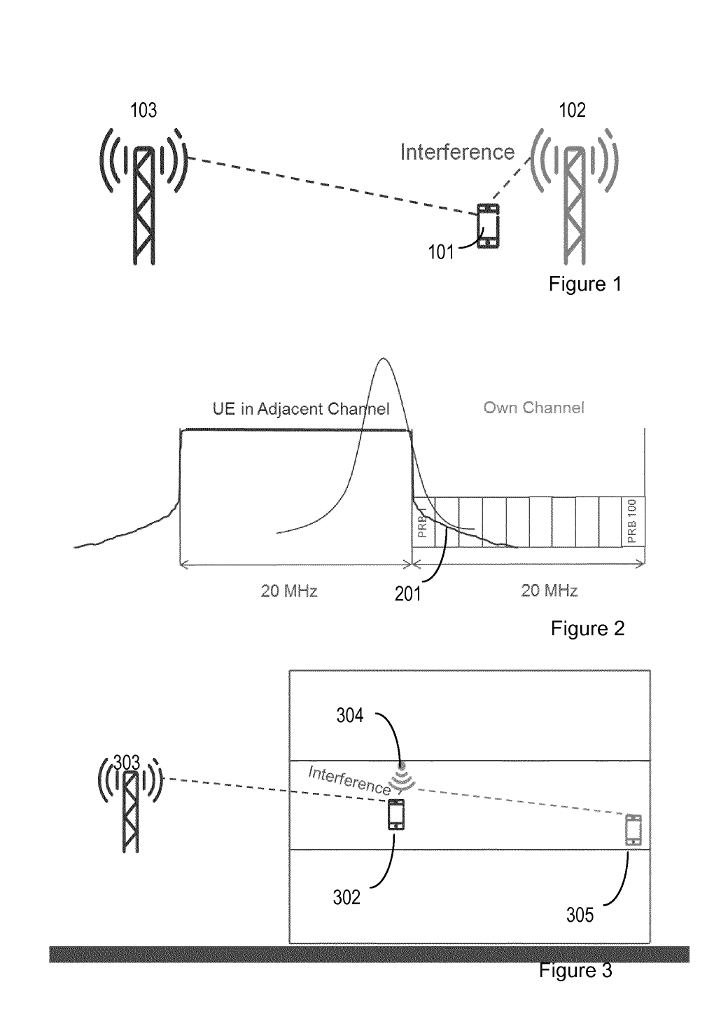

Due to the statistic distribution of the ACI over RBs, it can be identified by analyzing the accumulated interference on spectrum edge vs the accumulated interference on spectrum center. An algorithm for this is described below with reference to FIG. 2.

FIG. 8 shows an accumulated interference over a frequency spectrum associated with the PUSCH of a cell. The X-axis corresponds to RBs, and the Y-axis corresponds to accumulated interference, in units, during a time period T. The following parameters are defined for analyzing the accumulated interference:

RB_m: A resource block in the center of the spectrum. For cell bandwidths of e.g. 10 MHz & 20 MHz, the center resource block will not be affected by ACI, and may therefore be used for representing an average interference level without ACI impact.

RB_first: The first resource block used by PUSCH in the spectrum.

RB_highACI: A resource block that separates the spectrum into high and lower ACI range.

Delta: A threshold introduced so that the algorithm can tolerate a certain degree of interference variation.

The algorithm steps through the resource blocks, starting from the center resource block and moving towards lower numbered resource blocks. When a RB associated with an accumulated interference level which is higher than the accumulated interference value associated with the center RB+Delta, this is where the spectrum will be divided into ranges. The algorithm will be expressed in commented code below.

Further, a smoothing algorithm, such as a Gaussian Kernel smoother, moving average can be applied to the interference values before performing a trend analysis, in order to get rid of the turbulent points. Such smoothed interference values are illustrated in FIG. 8.

RB_x = RB_m; // start from the middle resource block
While (RB_x != RB_first)
{
If (I_RB_x <= I_RB_m + Delta)

//interference is within defined threshold
//move one resource block towards beginning of the spectrum
RB_x = RB_x−1;

Else

//higher interference detected. Start high ACI area.
RB_highACI = RB_x

}

The same procedure should be performed for the other half of the spectrum.

The ACI area can be further confirmed e.g. by comparing the average accumulated interference over the two ranges, i.e. comparing the average accumulated interference in the range RB_first to RB_highACI, and the average accumulated interference in the range RB_highACI to RB_middle. A criterion which needs to be met in order to make a decision about dividing the spectrum may then be formulated e.g. as below. In other words, it may be concluded that ACI is detected when the following expression is TRUE:

If I_RB_first>I_average_RB_first_to_RB_highACI>I_average_RB_highACI_to_RB_m

Reducing the ACI Impact

In an exemplifying embodiment, the PRB resources are divided into two ranges; one low ACI range, and one high ACI range, separated by the RB_highACI, as described above.

If the cell load is low, e.g. below a load threshold, the UEs should be allocated to the low ACI area.

In case the cell load is high, e.g. exceeds a load threshold, the UEs close to the cell center that have low pathloss will be less impacted of ACI than UEs having a high pathloss. The UEs associated with low pathloss, e.g. a pathloss below a threshold, can thus be allocated to the high ACI range. The UEs that have a higher pathloss, e.g. being located close to the cell border, will be allocated to the low ACI range. The UE's data type may also be taken into account when allocating UEs to the different ranges, such that UEs having a GBR, are located in the low ACI range, while UEs being scheduled with so-called “Best Effort” are located in the high ACI range.

Implementations:

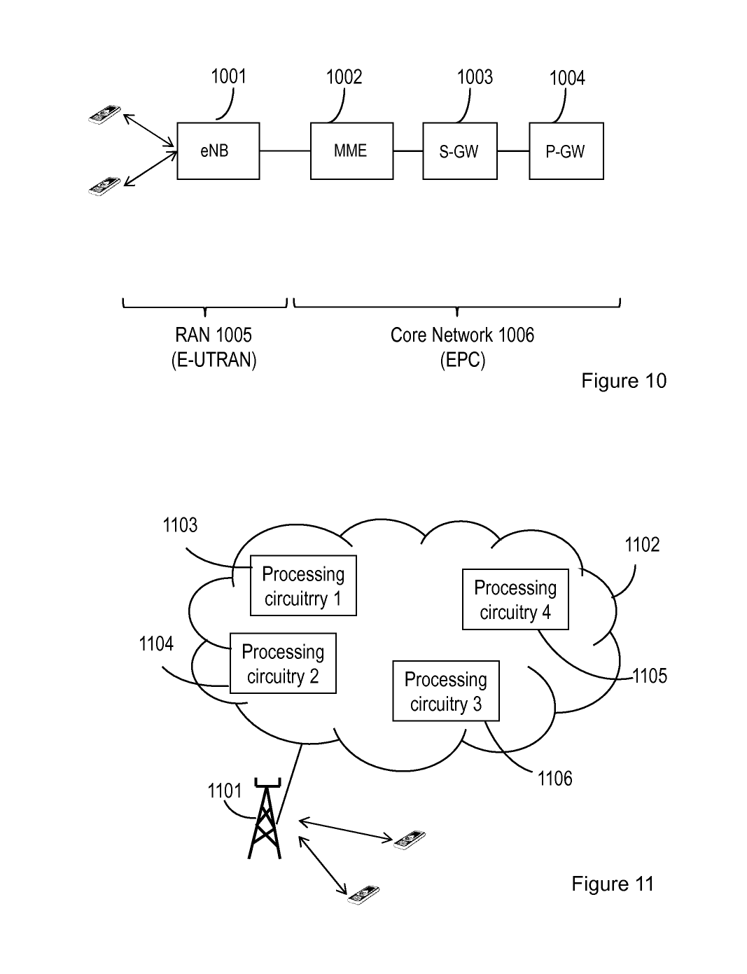

The methods and techniques described above may be implemented in a wireless communication network, e.g. in one or more network nodes, such as e.g. radio access nodes, such as eNBs or IRUs, and/or in one or more core network nodes. The methods could be implemented in a distributed manner, e.g. a plurality of nodes or entities could each perform a part of the actions e.g. at different locations in the network. For example, one or more embodiments could be implemented in a so-called cloud solution, or a “Centralized RAN” or “Split Architecture”, where e.g. an eNodeB is divided into 2 or more separate nodes. Correspondingly, the network could be configured such that actions of the method embodiments are performed e.g. partly in a radio access node and partly in a core network node. The distributed case could be described as that the method is performed by an arrangement or a network node operable in the communication network, but that the arrangement or the network node could be distributed in the network, and not necessarily be comprised in a physical unit e.g. close to an antenna. Examples of distributed and non-distributed implementations will be given further below, with reference to FIGS. 10 and 11.

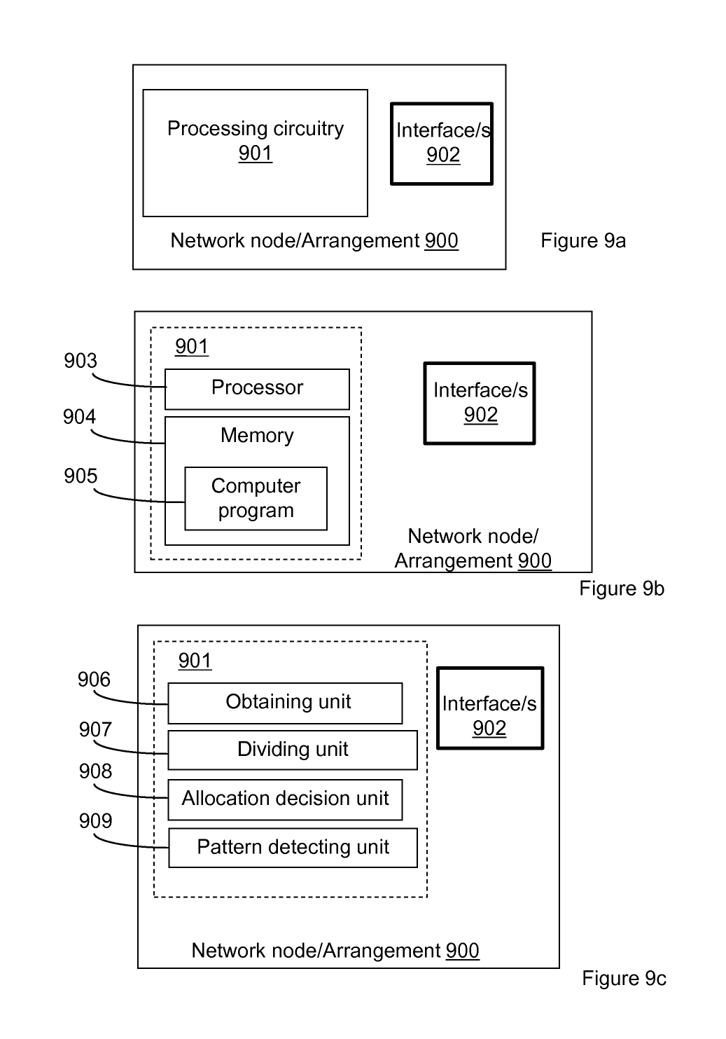

Network Node and Arrangement Operable in a Wireless Communication Network, FIGS. 9a-9c

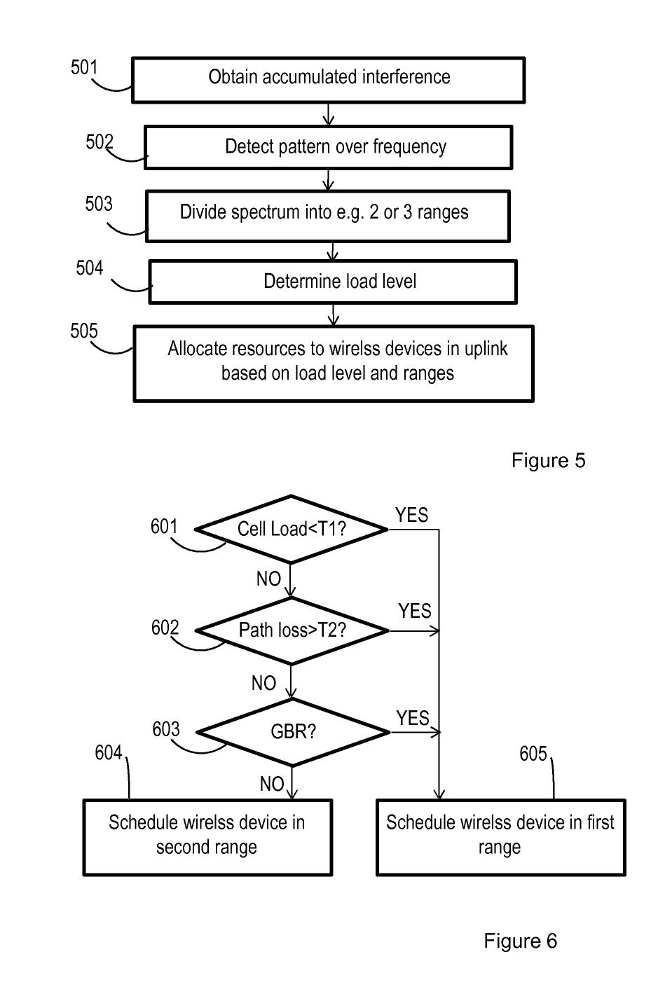

An exemplifying embodiment of a network node or an arrangement operable in a wireless communication network is illustrated in a general manner in FIG. 9a. The network node may, as previously described, e.g. together with one or more other network nodes and/or resources or entities, represent the wireless communication network when communicating with wireless devices. The network node or arrangement 900 is configured to perform at least one of the method embodiments described above with reference to any of FIGS. 4-8. The network node or arrangement 900 is associated with the same technical features, objects and advantages as the previously described method embodiments. The communication network will be described in brief in order to avoid unnecessary repetition.

The network node or arrangement may be implemented and/or described as follows:

The network node or arrangement 900 comprises processing circuitry 901, and one or more communication interfaces 902. The processing circuitry may be composed of one or more parts which may be comprised in one or more nodes in the communication network, but is here illustrated as one entity.

The processing circuitry 901 is configured to cause the network node or arrangement 900 to obtain an accumulated uplink interference for a time period, Ti, over a frequency spectrum associated with an uplink communication channel of the wireless communication network. The processing circuitry 901 is further configured to cause the network node or arrangement to divide the frequency spectrum into at least a first and a second range based on characteristics of the obtained accumulated interference; and to apply different rules for allocation of resources to wireless devices for uplink communication in the link in the first and second range. The one or more communication interfaces 902, which may also be denoted e.g. Input/Output (I/O) interfaces, include a network interface for sending data between nodes or entities in the communication network.

The processing circuitry 901 could, as illustrated in FIG. 9b, comprise one or more processing means, such as a processor 903, and a memory 904 for storing or holding instructions. The memory would then comprise instructions, e.g. in form of a computer program 905, which when executed by the one or more processing means 903 causes the network node or arrangement 900 to perform the actions described above. The processing circuitry 901 may, as previously mentioned be composed of one or more parts and be comprised in, or distributed over, one or more nodes in the communication network as illustrated in FIGS. 10 and 11, but is here illustrated as one entity.

An alternative implementation of the processing circuitry 901 is shown in FIG. 9c. The processing circuitry here comprises an obtaining unit 906, configured to cause the network node or arrangement to obtain an accumulated uplink interference for a time period, Ti, over a frequency spectrum associated with an uplink communication channel of the wireless communication network. The processing circuitry further comprises a dividing unit 907, configured to cause the network node or arrangement to divide the frequency spectrum into at least a first and a second range based on characteristics of the obtained accumulated interference. The processing circuitry further comprises an allocation decision unit 908, configured to cause the network node or arrangement to apply different rules for allocation of resources to wireless devices for uplink communication in the channel in the first and second range. The processing circuitry could comprise more units, such as e.g. a pattern detecting unit 909 for detecting a first type of pattern in the accumulated uplink interference. The processing circuitry 901 may, as previously mentioned be comprised in, or distributed over, one or more nodes in the communication network, but is here illustrated as comprised in one entity.

The network nodes and arrangements described above could be configured for the different method embodiments described herein, e.g. in regard of the detection of a first type of pattern, and updating of the division into at least a first and a second region.

FIG. 10 illustrates an exemplifying wireless communication network, in this case an LTE network, in which the herein suggested solution may be implemented and applied. Wireless communication networks are often described in terms of a Radio Access Network, RAN 1005, and a Core network 1006. In LTE these are denoted E-UTRAN and EPC. The E-UTRAN 1005 comprises radio access nodes 1001, which are denoted eNBs. The EPC 1006 comprises core network nodes such as MME 1002, S-GW 1003 and P-GW 1004. The solution described herein could be implemented in one or more nodes in a network. For example, in the exemplifying network illustrated in FIG. 10, the functionality for performing the solution described herein could be implemented in the radio access node 1001, which would then—obtain the accumulated uplink interference of a channel, divide the frequency spectrum into at least a first and a second range, and apply different rules for allocation of resources, etc. Alternatively, the functionality could be implemented in a core network node, such as the MME 1002 or some other control node. In that case, the core network node would e.g. obtain the accumulated uplink interference of a channel, divide the frequency spectrum into at least a first and a second range and inform the RAN node 1001 of the division, and induce the RAN node 1001 to apply different rules for allocation of resources, e.g. by configuring the RAN node 1001 with the rules. The functionality could alternatively be implemented in more than one node, e.g. such that the obtaining of an accumulated uplink interference and the division into ranges are performed by the MME 1002; and the applying of different rules for allocation of resources, e.g. the actual allocation of resources according to a set of rules, is performed by the eNB 1001.

FIG. 11 also illustrates an exemplifying wireless communication network, in which the herein suggested solution may be implemented. FIG. 11 intends to illustrate a so-called cloud solution, where resources e.g. in form of cloud entities comprising processing capacity or processing circuitry 1003-1006, in different locations may be used for implementing a certain functionality. The resources need not necessarily be located close to the antenna or access node 1101, but may be located in another country. Such resources may be owned by the network provider or operator, or may be provided or rented from a third party. In this type of solution, the functionality associated with a radio access node, e.g. such as the node 1001 in FIG. 10, could be implemented in one or more servers or entities located different geographic positions. In regard of the solution described herein, the functionality for obtaining e.g. collecting the accumulated uplink interference of a channel could be implemented in cloud entity 1103. The dividing of the frequency spectrum into at least a first and a second range could be implemented as a cooperation between cloud entities 1104 and 1105, and the applying of rules for allocation of resources could be implemented in cloud entity 1106. This is an example of a distributed solution.

The steps, functions, procedures, modules, units and/or blocks described herein may be implemented in hardware using any conventional technology, such as discrete circuit or integrated circuit technology, including both general-purpose electronic circuitry and application-specific circuitry.

Particular examples include one or more suitably configured digital signal processors and other known electronic circuits, e.g. discrete logic gates interconnected to perform a specialized function, or Application Specific Integrated Circuits (ASICs).

Alternatively, at least some of the steps, functions, procedures, modules, units and/or blocks described above may be implemented in software such as a computer program for execution by suitable processing circuitry including one or more processing units. The software could be carried by a carrier, such as an electronic signal, an optical signal, a radio signal, or a computer readable storage medium before and/or during the use of the computer program e.g. in one or more nodes of the wireless communication network. The processing circuitry described above may be implemented in a so-called cloud solution, referring to that the implementation may be distributed, and may be referred to e.g. as being located in a so-called virtual node or a virtual machine.

The flow diagram or diagrams presented herein may be regarded as a computer flow diagram or diagrams, when performed by one or more processors. A corresponding arrangement or apparatus may be defined as a group of function modules, where each step performed by a processor corresponds to a function module. In this case, the function modules are implemented as one or more computer programs running on one or more processors.

Examples of processing circuitry includes, but is not limited to, one or more microprocessors, one or more Digital Signal Processors, DSPs, one or more Central Processing Units, CPUs, and/or any suitable programmable logic circuitry such as one or more Field Programmable Gate Arrays, FPGAs, or one or more Programmable Logic Controllers, PLCs. That is, the units or modules in the arrangements in the communication network described above could be implemented by a combination of analog and digital circuits in one or more locations, and/or one or more processors configured with software and/or firmware, e.g. stored in a memory. One or more of these processors, as well as the other digital hardware, may be included in a single application-specific integrated circuitry, ASIC, or several processors and various digital hardware may be distributed among several separate components, whether individually packaged or assembled into a system-on-a-chip, SoC.

It should also be understood that it may be possible to re-use the general processing capabilities of any conventional device or unit in which the proposed technology is implemented. It may also be possible to re-use existing software, e.g. by reprogramming of the existing software or by adding new software components.

The embodiments described above are merely given as examples, and it should be understood that the proposed technology is not limited thereto. It will be understood by those skilled in the art that various modifications, combinations and changes may be made to the embodiments without departing from the present scope. In particular, different part solutions in the different embodiments can be combined in other configurations, where technically possible.

When using the word “comprise” or “comprising” it shall be interpreted as non-limiting, i.e. meaning “consist at least of”.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

1. A method performed in a wireless communication network, the method comprising:
obtaining an accumulated uplink interference for a time period, Ti, over a frequency spectrum associated with an uplink communication channel of the wireless communication network; and
dividing the frequency spectrum into at least a first and a second range based on characteristics of the obtained accumulated interference; and
applying different rules for allocation of resources to wireless devices for uplink communication in the channel in the first and second range.

2. The method according to claim 1, wherein the dividing into at least a first and a second range is performed when a first type of pattern over frequency is detected in the obtained accumulated interference.

3. The method according to claim 2, wherein the first type of pattern is detected based on analysis of changes in the accumulated interference between spectrum edge and spectrum center.

4. The method according to claim 1, wherein the division into ranges is performed at frequencies or resource blocks where the accumulated interference meets a threshold.

5. The method according to claim 1, wherein the first range is associated with a lower accumulated interference than the second range.

6. The method according to claim 1, wherein the frequency spectrum is divided into 2 or 3 ranges.

7. (canceled)

8. The method according to claim 1, further comprising:
obtaining an accumulated uplink interference for a time period, Tᵢ₊ₓ over the frequency spectrum; and
updating the division of the spectrum into at least a first and a second range based on the characteristics of the accumulated uplink interference for the time period, Tᵢ₊ₓ

9. The method according to claim 1, wherein the rules for allocating resources comprises that wireless devices are allocated resources for uplink communication in the first range at a first load level of the network.

10. The method according to claim 1, wherein the rules for allocating resources comprises that wireless devices associated with a pathloss exceeding a threshold are allocated resources for uplink communication in the first range at a second load level.

11. The method according to claim 1, wherein the rules for allocating resources comprises that wireless devices associated with a pathloss below a threshold are allocated resources for uplink communication in the second range at a second load level.

12-14. (canceled)

15. A network node operable in a wireless communication network, being configured to:
obtain an accumulated uplink interference for a time period, Ti, over a frequency spectrum associated with an uplink communication channel of the wireless communication network;
divide the frequency spectrum into at least a first and a second range based on characteristics of the obtained accumulated interference; and to
apply different rules for allocation of resources to wireless devices for uplink communication in the channel in the first and second range.

16. The network node according to claim 15, being configured to divide the frequency spectrum into at least a first and a second range when a first type of pattern over frequency is detected in the obtained accumulated interference.

17. The network node according to claim 16, being configured to detect the first type of pattern based on analysis of changes in the accumulated interference between spectrum edge and spectrum center.

18. The network node according to claim 15, being configured to perform the division into ranges at frequencies or resource blocks where the accumulated interference meets a threshold.

19. (canceled)

20. The network node according to claim 15, being configured to divide the frequency spectrum into 2 or 3 ranges.

21. The network node according to claim 15, wherein the accumulated interference is measured over the time period Ti which has a duration of at least:
15 minutes;
1 hour; or
5 hours

22. The network node according to claim 15, being further configured to:
obtain an accumulated uplink interference for a time period, Tᵢ₊ₓ over the frequency spectrum; and to
update the division of the spectrum into at least a first and a second range based on the characteristics of the accumulated uplink interference for the time period, Tᵢ₊ₓ

23. The network node according to claim 15, wherein the rules for allocating resources comprises that wireless devices are allocated resources for uplink communication in the first range at a first load level of the network.

24. The network node according to claim 15, wherein the rules for allocating resources comprises that wireless devices associated with a pathloss exceeding a threshold are allocated resources for uplink communication in the first range at a second load level.

25. The network node according to claim 15, wherein the rules for allocating resources comprises that wireless devices associated with a pathloss below a threshold are allocated resources for uplink communication in the second range at a second load level.

26-44. (canceled)
